(19) United States
(12) Patent Application Publication
(10) Pub. No.: US 2006/0277991 A1
(43) Pub. Date: Dec. 14, 2006

(54) Systems, methods and devices relating to dive computers

(76) Inventor: Michael J. Dahan, Thousand Oaks, CA (US)

Correspondence Address: Corey Scott, 2620 Marcilee Way, Rancho Cordova, CA, 95670, US

(21) Appl. No.: 11/384,721

(22) Filed: Mar. 20, 2006

Related U.S. Application Data
(60) Provisional application No. 60/663,154, filed on Mar. 18, 2005.

(51) Int. Cl. G01F 23/00

(52) U.S. Cl. 73/299

(57) ABSTRACT

A dive computer having multiple sensors and voting logic to determine accuracy of sensor reading. The invention provides, in various embodiments, aspects of a safer dive computer capable of detecting and eliminating erroneous sensor measurement readings and systems and methods relating to determination thereof.

### REFERENCE TO RELATED APPLICATIONS

This application claims priority to and the benefit of U.S. Provisional patent application Ser. No. 60/663,154, filed on Mar. 18, 2005 and entitled “Dive Computer with redundant sensors and voting logic,” the entire contents of which are incorporated herein by reference.

### FIELD OF THE INVENTION

This invention relates to a diving measuring device and methods for safer production thereof. In particular, a diving computer with multiple water sensors and a microprocessor for processing information therefrom is disclosed.

### BACKGROUND OF THE INVENTION

A risk of diving with a Self Contained Underwater Breathing Apparatus (SCUBA) is the development of decompression sickness (hereafter called DCS, but commonly called “the bends”). DCS is a general term that includes a number of signs and symptoms whose common etiology is the formation of inert gas bubbles in one or more parts of the body and whose most frequent manifestations are joint pain and central nervous system damage, ranging in severity from temporary mild discomfort to sudden death. While many different gas combinations are used in military and commercial diving, recreational divers typically breathe compressed air, which is 79% nitrogen, and nitrogen is the inert gas relevant to this discussion.

A recreational diver at depth breathes air at a pressure greater than at the surface and becomes of this gradient, nitrogen passes through the lung membranes into solution in the blood, and from there into the various tissues of the body, at varying rates that depend upon the magnitude of said pressure gradient and upon characteristics of each of said various tissues. When the diver returns to the surface, the reverse process occurs: the higher pressure nitrogen dissolved in the blood passes through the lung membranes and is exhaled, and as the nitrogen pressure in the blood diminishes, dissolved nitrogen passes from the tissues to the blood until eventually all portions of the body have reached equilibrium with atmospheric pressure; stated simply, pressure changes flow from high to low.

If a diver stays at a given depth of water long enough for any of his tissue pressures to exceed the limit at which it becomes impossible to undergo this normal process of gas elimination, and said tissue pressure is sufficiently greater than that of the surrounding environment, then nitrogen bubbles can form in a body tissue and that diver could develop DCS. To minimize this risk, the diver must either avoid such depth and time combinations, or must undergo the procedure known as decompression, which requires staying at predetermined depths for predetermined time periods so as to eliminate the dangerous excess of nitrogen pressure. In recreational diving, decompression is considered to be an emergency procedure only, for use when well known time/depth limits, or no-decompression limits, have been accidentally exceeds. Because of the dangers associated with the procedure, it is not considered to be an elective option.

If a diver planned only a single dive to a single depth, the requirements would be simple: the diver should never exceed the empirically determined no decompression limit for that depth. However, it is commonplace for divers to perform two or more dives in succession, and the excess nitrogen in the body cannot reach equilibrium with the atmosphere in the short time span(s) between dives. Thus, a diver would reenter the water with a tissue nitrogen pressure greater than atmospheric, and must allow for said greater pressure in computing the maximum time permissible at depth during a subsequent dive. To avoid decompression procedures, a satisfactory adjustment factor must be employed. It is therefore essential that the recreational diver have a means instantly available at all times to compute with speed, ease, and precision the amount of time which he can spend at any depth without exceeding the limit of time for that depth, and if more diving is planned within a short period, he/she must also be able to calculate the amount of nitrogen pressure lost during the time spent on the surface between dives, so that the net accumulation and loss of nitrogen pressure in the body tissues may be safely and accurately tracked over a succession of dives.

A diving computer has the important task of helping to ensure that the above-mentioned damage does not occur. The diving computer taken along during a dive determines the diving profile of the diver dependent upon time, and calculates based thereupon, using known formulas or tables, the nitrogen increase or decrease, respectively, in the human body during the time the diver spends at a greater or lesser depth. In particular the diving computer indicates to the diver how he should rise to the surface and how long he should spend at which diving depths so that the aforementioned formation of gas bubbles in the blood does not occur.

Calculations are made with microprocessors and display of diving data today takes place preferably using a liquid crystal display (LCD). Depth measurements are performed by pressure transducers. A microprocessor calculates depth based on information it receives from the transducer. Presently manufactured dive computers have a single pressure sensor. An erroneous reading or faulty depth sensor cannot be detected and thus, a threat of DCS is present.

Accordingly, there is a need for improved systems, devices and methods for safer diving computers.

### SUMMARY OF THE INVENTION

The invention addresses the deficiencies in the prior art by, in various embodiments, providing improved systems, devices and methods relating safer diving computers. More particularly, in some embodiments, the invention provides an improved dive computer that included redundant sensors with logic circuitry for determining the most accurate sensor readings. In other embodiments, the invention provides methods for receiving variant sensor information and determining erroneous sensor information.

These and other features, embodiments and aspects of the invention will be further understood with reference to the description of the illustrative embodiments.

### BRIEF DESCRIPTION OF THE DRAWINGS

Illustrative embodiments of the invention are described below with reference to the appended drawings, in which like parts have like reference designations and in which the various depicted parts may not be drawn to scale. The depicted embodiments are to be understood as illustrative of the invention and not as limiting in any way.

FIGS. 1 illustrate a block diagram of a dive computer according to an illustrative embodiment of the invention.

### DETAILED DESCRIPTION

As described, the invention relates to a diver's computer which includes detectors for measuring and determining diving parameters and a processor for processing the measured and determined data of diving parameters, and memory functions for storage of the measured and collected data. The invention also relates to a method for analyzing data relating to diving parameters obtained by a diving computer.

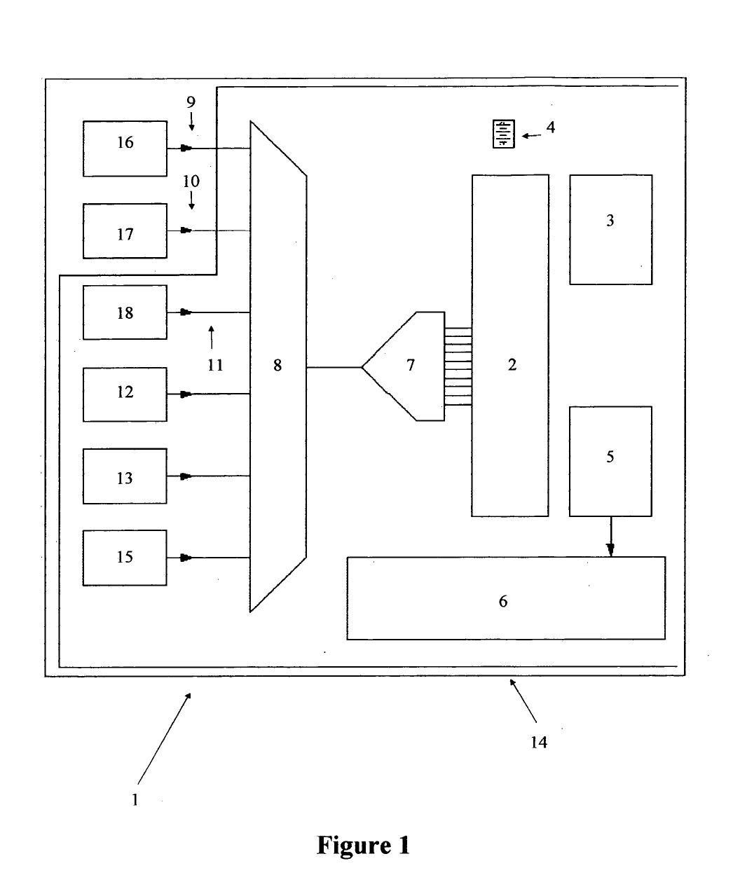

Turning to the depicted illustrative embodiments, FIG. 1 illustrates a block diagram pursuant to the construction of a dive computer according to one embodiment of the invention. Voting dive computer 1 includes microcontroller 2, memory 3, battery 4, display interface 5, LCD display 6, ADC 7, MUX 8, communication conduit 9, communication conduit 10, wire 11, acceleration sensor 12, temperature sensor 13, humidity sensor 15, pressure sensor 16, pressure sensor 17, and pressure sensor 18.

Pressure sensors 16, 17 and 18 are transducers disposed on case 14 and interface with ambient water (not depicted) according to a first embodiment. Pressure sensors 16, 17 and 18 measure ambient pressure and output electrical signals indicative thereof. The outputted electrical signals are analog, but in other embodiments, the signals are digital. Outputted electrical signals from pressure transducer 16 are transmitted through communication conduit 9. Similarly, outputted electrical signals from pressure transducer 17 are transmitted through communication conduit 10.

In one or more embodiments, communication conduits 9, 10 are wireless transmissions, such as, a Radio Frequency (RF), Ultra-low frequency, WiFi or bluetooth type devices. In other embodiments, communications conduits are direct electrical communications, e.g., a wire or other conductive traces. Pressure sensor 12 is transmitted directly to MUX 8 through communication conduit 11. In one embodiment, communication conduit is a wire but can be any transmission system like a wireless device.

Acceleration sensor 12 measure the acceleration experienced by voting dive computer 1. Acceleration sensor 12 is an accelerometer in certain embodiments. Electrical signals indicative of experienced acceleration are communicated to MUX 8 through a wire. Temperature sensor 13 measures ambient temperature and communicates electrical signals of such to MUX 8. Humidity sensor 15 measures ambient humidity of voting dive computer 1—typically water immersion—and transmits electrical signals indicative thereof to MUX 8.

MUX 8 receives information from pressure sensor 16, pressure sensor 17, pressure sensor 18, acceleration sensor 12, temperature sensor 13 and humidity sensor 15. In one or more embodiments, MUX 8 is an analog multiplexer. In other embodiments, MUX 8 is a digital multiplexer where the sensor signals have been previously sampled. MUX 8 combines (time division multiplexing) sensor signals and communicates the result to ADC 7. ADC 7 is an analog-to-digital converter. ADC 7 periodically samples the combined sensor signal and outputs a digital signal. In certain embodiments, the sampling is executed at a 10-bit resolution, but it can be any number of bits.

Microcontroller 2 receives the sensor data from MUX 8. Microcontroller 2 is a microprocessor but can be any integrated circuit. By way of example, microcontroller 2 can be a programmable gate array (PGA) or a programmable logic device (PLD), e.g., programmable read only memory (PROM), programmable logic array (PLA), programmable array logic/generic array logic (PAL/GAL), etc. In one embodiment, memory 3 is random access memory (RAM) and in electrical communication with microcontroller 2. In certain embodiments memory is read only memory (ROM) or a combination of ROM or RAM. Battery 4 powers the device; yet, any suitable power supply can supply power to voting dive computer either in whole or part:

Microcontroller 2 determines the most accurate depth measurement based on, at least in part, sampled signals from pressure sensors 16, 17 and 18. In particular, sensor readings from pressure sensors 16, 17 and 18 are compared for congruency. If depth measurements based on sensor readings from pressure sensors 16, 17 and 18 are all within a predetermined tolerance (e.g., 2 ft.), no sensor error has occurred. If no error has be deemed, microcontroller 2 determines a depth measurement based on all three sensor readings from pressure sensors 16, 17 and 18. In certain illustrative embodiments, this can be an average of the sensor readings from pressure sensors 16, 17 and 18. Alternatively, the depth measurement can be based on the two closest sensor readings from pressure sensors 16, 17 and 18.

An error occurs when microcontroller 2 finds one sensor readings from pressure sensors 16, 17 and 18 out of tolerance from one another. Specifically, if two sensor readings from pressure sensors 16, 17 and 18 are within 2 ft. and the remaining sensor reading from pressure sensors 16, 17 and 18 does not fall within this range, microcontroller 2 flags for error. Upon an error determination, microcontroller 2 performs a depth measure exclusively based on the two sensor readings from pressure sensors 16, 17 and 18 which are within the predetermined range of one another. In particular, the sensor reading from pressure sensors 16, 17 and 18 that falls out of the predetermined tolerance is excluded from depth measurements, either temporarily or otherwise.

In the event that all three sensor readings from pressure sensors 16, 17 and 18 are all out of tolerance with on another, an abort error occurs in which the dive is aborted (discussed in more detail later).

In an alternate illustrative embodiment, accurate depth measurements are based on only two sensor readings from pressure sensors—especially, if only two are present. The two sensor readings would be compared to determine if they are within tolerance of each other. If the two sensor reading fall with a predetermined range, a depth measurement is based on both sensor readings. If the two sensor are out of tolerance with each other, an accurate depth measurement is based on several factor including, but not limited to, sensor reading history and humidity sensor 15 information. For example, microcontroller 2 reviews the history of two pressure sensors. Discreet jumps in history would indicate an error in which case information from the pressure sensor in question would be excluded from depth measurement calculations.

Furthermore, information from humidity sensor 15 is used to the exclude erroneous sensor readings either at depth or on the surface. Specifically, if information from humidity sensor 15 indicated voting dive computer 1 is immersed in water, then microcontroller 2 excludes a pressure sensor reading of 0 (on the surface). Conversely, if information from humidity sensor 15 indicated voting dive computer 1 is in an air environment (on the surface), then microcontroller 2 excludes a pressure sensor reading anything greater than the predetermined tolerance (i.e., greater than 2 ft.).

The accurate depth measure is sent to display interface 5. Display interface is any integrated circuit used to receive information and control said information on a display screen. LCD display 6 is a liquid crystal display, but in other embodiments, the display can be any suitable device, such as, as light emitting diode (LED) or flat panel display. Displayed objects include, but are not limited to, sensor errors, compromised measurements, and abort dive. As described previously, a sensor error can indicate a sensor error in a two pressure sensor system. A compromised measurement can indicate a sensor error in a three pressure sensor system. And, an abort dive display object can indicate three sensors out of tolerance in a three pressure sensor system. In certain illustrative embodiments, other suitable objects are displayed or some of the aforementioned objects are eliminated from display. According to one aspect of the invention, any object or error can be displayed as a illuminated flash or audible sound, such as a beep.

In certain embodiments, pressure sensors 16, 17, and 18 are transducers disposed in a manner to receive and measure tank pressure. For example, pressure sensors 16, 17, and 18 are connected to the high pressure port on the first stage of a scuba diving regulator; however, pressure sensors 16, 17, and 18 can be disposed in any suitable location to interface with tank gasses.

Microcontroller 2 determines accurate tank pressure based on, at least in part, sampled signals from pressure sensors 16, 17 and 18. In particular, sensor readings from pressure sensors 16, 17 and 18 are compared for congruency. If depth measurements based on sensor readings from pressure sensors 16, 17 and 18 are all within a predetermined tolerance (e.g., 15 psi), no sensor error has occurred. If no error has be deemed, microcontroller 2 determines a tank pressure based on all three sensor readings from pressure sensors 16, 17 and 18. In certain illustrative embodiments, this can be an average of the sensor readings from pressure sensors 16, 17 and 18. Alternatively, the depth measurement can be based on the two closest sensor readings from pressure sensors 16, 17 and 18 or any other suitable calculation.

An error occurs when microcontroller 2 finds one sensor readings from pressure sensors 16, 17 and 18 out of tolerance from one another. Specifically, if two sensor readings from pressure sensors 16, 17 and 18 are within 15 psi and the remaining sensor reading from pressure sensors 16, 17 and 18 does not fall within this range, microcontroller 2 flags for error. Upon an error determination, microcontroller 2 performs tank pressure estimation exclusively based on the two sensor readings from pressure sensors 16, 17 and 18 which are within the predetermined range of one another. In particular, the sensor reading from pressure sensors 16, 17 and 18 that falls out of the predetermined tolerance is excluded from depth measurements, either temporarily or otherwise.

Variations, modifications, and other implementations of what is described may occur without departing from the spirit and the scope of the invention.

What is claimed is:

1. A dive computer comprising:
a plurality of pressure sensors, each of the plurality of pressure sensors outputting a sensor signal; and
a circuit for calculating pressure in electrical communication with the plurality of pressure sensors;
wherein, the circuit is capable of excluding at least one of the sensors signals from calculations.

2. The dive computer according to claim 1 further comprising an analog-to-digital converter electrically disposed between the circuit and the plurality of pressure sensors.

3. The dive computer according to claim 2 further comprising a multiplexer electrically disposed between the analog-to-digital converter and the plurality of pressure sensors.

4. The dive computer according to claim 1, wherein the circuit comprises, at least in part, a comparator.

5. The dive computer according to claim 1, wherein the circuit is a digital circuit.

6. The dive computer according to claim 1, wherein the circuit determines whether the plurality of sensor signals are within a predetermined range.

7. The dive computer according to claim 1, wherein the circuit calculates depth based on at least one of the sensor signals.

8. The dive computer according to claim 1, wherein the circuit calculates tank pressure based on at least one of the sensor signals.

9. The dive computer according to claim 1 further comprising an alarm, the alarm activated when at least one sensor signal is excluded from calculation.

10. A method for comparing sensor readings in a dive computer comprising:
receiving a first signal from a first transducer;
receiving a second signal from a second transducer;
receiving a third signal from a third transducer;
comparing the first, second and third signals; and
determining whether the first, second and third signals are within a predetermined range.

11. The method according to claim 10 further comprising displaying information relating an environmental parameter based on, at least in part, all signals within the predetermined range.

12. The method according to claim 10 wherein, the first, second and third signals are indicative of pressure.

13. The method according to claim 10 further comprising:
calculating pressure; and
excluding at least one of the first, second and third signals from the calculation, if the at least one signal is not within the predetermined range.

14. The method according to claim 13 further comprising emitting a warning if a calculation exclusion occurs.

15. The method according to claim 10 further comprising digitally sampling the first, second and third signals.
